(19) United States
(12) Patent Application Publication
(10) Pub. No.: US 2006/0021036 A1
(43) Pub. Date: Jan. 26, 2006

(54) Method and system for network security management

(75) Inventors: Shao-Ning Chang, Taipei (TW); Hong-Wei Tzeng, Cih-Tong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ICP Electronics Inc.

(21) Appl. No.: 11/020,715

(22) Filed: Dec. 23, 2004

(30) Foreign Application Priority Data
Jul. 26, 2004 (TW) 93122258

(51) Int. Cl. G06F 12/14

(52) U.S. Cl. 726/22

(57) ABSTRACT

A method for network security management using an Internet key exchange mechanism. A user database is established at a server comprising a plurality of first usernames and a plurality of corresponding first passwords. A second username and corresponding password are embedded into a shared key. A client key value is derived according to the shared key and Internet key exchange mechanism. The first user-names and corresponding first passwords are calculated and obtained for generating a plurality of user key values. The client key value is added into a first message and transferring the first message to the server. The client key value is compared with the user key values, and, when the client key value matches one user key value, the second username and corresponding password are calculated to generate a server key value

### BACKGROUND

The invention relates to data management, and in particular to a method and system for network security management.

Virtual private networks (VPN) utilize the public networks to replace local area networks of enterprises for lower cost and higher expandability. Virtual private networks comprise Customer Premises Equipment-based (CPE-based) VPNs and network-based VPNs. The most popular VPN solution is that the CPE-based VPN creates a virtual private tunnel over the public network to remote CPE-based VPN devices using a Layer 2 Tunneling Protocol (L2TP) or an IP Security Protocol (IPSec).

IPSec is-an encryption method widely used in network communication applications, with maintaining network security to establish a VPN. Security services provided by a VPN using IPSec comprise data confidentiality, content integrity, and data authentication. To achieve the described security services, IPSec uses encryption methods, such as DES, 3DES, and AES, and hash functions, such as MD5 and SHA-1, to provide different security protocols (AH or ESP) or packet modes (Transport mode or Tunnel mode) according to user requirements.

IPSec enables users to share secret data using “shared secret”. Users, however, share the only key, the system can just verify the key with single password, such that users cannot login a system with individual username and password, resulting in difficult in system security management.

### SUMMARY

Accordingly, an object of the present invention is to provide a method for data security management, enabling identity verification for individual user using a pre-shared key.

According to the object described, the present invention provides a method for network security management.

A user database is first established, comprising usernames and passwords for all users. A pre-shared key is divided into both username (UN) and password (PW) parts, indicating pre_share_secret=(UN|PW). Next, a first key is derived according to a secret key algorithm and the shared key, which is generated by a pseudo random function (PRF) referring to a HMAC-MD5 algorithm, indicating SKEYID=HMAC-MD5[(UN|PW), (N_{I}|N_{R})]. Next, the value of the first key is inserted into a message 5, and the message is transferred to the responder.

Next, the responder calculates key values of all users stored in the user database that is represented as HASH_I(UN₁, PW₁), HASH_I(UN₂, PW₂), . . . , HASH_I(UN_{N}, PWₙ), and restores the calculating result to the database. When receiving the first key value (HMAC_I) embedded in the message 5 from the initiator, the responder compares the first key value with the key values stored in the database. The responder calculates a key value thereof (HMAC_R) according to the comparing result and transfers the key value to the initiator. If the username and password embedded in the first key has been registered to the responder, the responder connects to the initiator, or refuses the connection.

The present invention further provides a system for network security management.

The system comprises a client, including an analysis unit, and a server, including a calculation unit, a comparison unit, and a user database comprising usernames and passwords of all users registered thereto, which indicates (UN₁, PW₁), (UN₂, PW₂), . . . , (UNₙ, PWₙ).

The analysis unit embeds a username and password of a user into a shared key, represented as pre_share_secret=(UN|PW), and derives a first key according to IKE definition and the shared key using a HMAC-MD5 algorithm, in which the first key indicates SKEYID=HMAC-MD5[(UN|PW), (N_{I}|N_{R})]. Next, the analysis unit insets a value of the first key into a message 5 and the client transfers the message to the server. The message 5 is an encryption message for identification protection to the client in IKE negotiation phase 1.

The calculation unit calculates key values of all users stored in the database that is represented as HASH_I(UN₁, PW₁), HASH_I(UN₂, PW₂), . . . , HASH_I(UN_{N}, PWₙ), and restores the calculating result to the user database. When the server receives the first key value (HMAC_I) embedded in the message 5 from the client, the comparison unit compares the first key value with key values of all user stored in the user database, and the calculation unit calculates a key value of the server (HMAC_R). If the username and password embedded in the first key has been registered to the server, the server connects to the initiator, or refuses the connection.

The method enables identity verification for individual user using a pre-shared key, enhancing protection of personal secret data and performance of system security management.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart showing the method for network security management according to the present invention; and

FIG. 2 is schematic diagram showing the system for network security management according to the present invention.

### DETAILED DESCRIPTION

The present invention discloses a method and system for network security management.

For being unable to verifying the username and password simultaneously, the method of the invention embeds a username and password into a pre-shared key and uses Internet Key Exchange (IKE) from Internet Engineering Task Force (IETF) and a private key algorithm for identify verification, in which the algorithm is Hass Message Authentication Code (HMAC).

IKE is a protocol for automatically creating, negotiating, modifying, and deleting security association (SA) between two hosts in the Internet. Information included in SA is used for creating a security tunnel between both sides in the Internet during data transmission, in which the information comprises. algorithms and keys for packet encryption or verification, life cycles of keys and SA, and serial numbers for avoiding duplicate attacking. IKE is performed based on Internet Security Association and Key Management Protocol (ISAKMP), and the ISAKMP structure supports Oakley and SKEME (Secure Key Exchange Mechanism for Internet) protocols. IPSec can manage, verify, and exchange SA safely based on IKE and provides verification of IPSec groups, IPSec key negotiation, and IPSec SA creation. Definitions of IPSec and IKE can be referenced in RFC (Request for Comments) 2401˜2409.

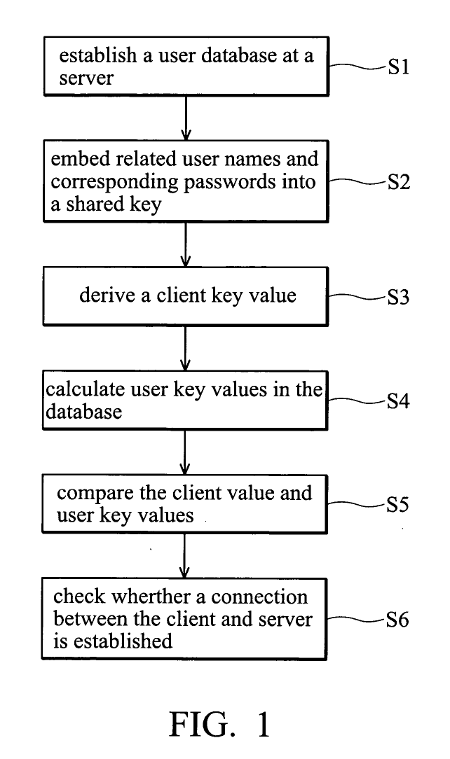

FIG. 1 is a flowchart showing the method for network security management according to the present invention.

A user database is first established, comprising usernames and passwords for all users (step S1).

A pre-shared key is divided into both username (UN) and password (PW) parts (step S2), indicating pre_share_secret=(UN|PW). Next, a first key is derived according to a secret key algorithm and the shared key (step S3), which is generated by a pseudo random function (PRF) referring to a HMAC-MD5 algorithm, indicating SKEYID=HMAC-MD5[(UN|PW), (N_{I}|N_{R})].

IKE adopts a main mode for user identify protection in negotiation phase 1, in which the main mode comprises six messages transferred between an initiator and a responder, which each sends three messages. Messages 1 and 2 refer to proposal and selection of an encryption method relating to the initiator and responder separately, and messages 3 and 4 refer to random numbers (N_{I} and N_{R}) of the initiator and responder separately, in which length of the numbers are from 64 to 2048 bits. Messages 5 and 6 encrypt identification data of the initiator and responder separately using the encryption method from the messages 1 and 2. The method of the invention inserts the value of the first key, combining username and password of a user, into the message 5, and transfers the message to the responder (step S4).

The user database comprises identification data (usernames and passwords) of all users registered to the responder, in which the data is represented as (UN₁, PW₁), (UN₂, PW₂), . . . , (UNₙ, PWₙ). Next, the responder calculates key values of all users stored in the user database that is represented as HASH_I(UN₁,PW₁), HASH_I(UN₂, PW₂), . . . , HASH_I(UNₙ, PWₙ), and restores the calculating result to the database (step S5). When receiving the first key value (HMAC_I) embedded in the message 5 from the initiator, the responder compares the first key value with the key values stored in the database (step S6). Next, the responder calculates a key value thereof (HMAC_R) according to the comparing result and transfers the key value to the initiator (step S7). If the username and password embedded in the first key has been registered to the responder, the responder connects to the initiator, or refuses the connection.

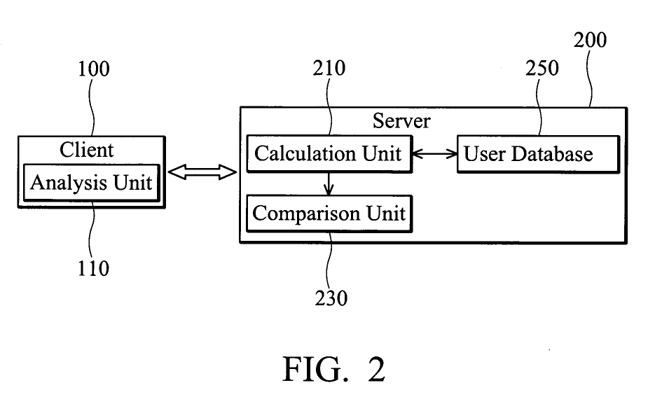

FIG. 2 is schematic diagram showing the system for network security management according to the present invention.

The system comprises a client 100, including an analysis unit 110, and a server 200, including a calculation unit 210, a comparison unit 230, and a user database 250 comprising usernames and passwords of all users registered thereto, which indicates (UN₁, PW₁), (UN₂, PW₂), . . . , (UNₙ, PWₙ).

Analysis unit 110 embeds a username and password of a user into a shared key, represented as pre_share_secret=(UN|PW), and derives a first key according to IKE definition and the shared key using a HMAC-MD5 algorithm, in which the first key indicates SKEYID=HMAC-MD5[(UN|PW), (N_{I}|N_{R})]. Next, Analysis unit 110 insets a value of the first key into a message 5 and client 100 transfers the message to server 200. The message 5 is an encryption message for identification protection to client 100 in IKE negotiation phase 1.

Calculation unit 210 calculates key values of all users stored in the database that is represented as HASH_I(UN₁, PW₁), HASH_I(UN₂, PW₂), . . . , HASH_I(UNₙ, PWₙ), and restores the calculating result to user database 250. When server 200 receives the first key value (HMAC_I) embedded in the message 5 from client 100, comparison unit 230 compares the first key value with key values of all user stored in user database 250, and calculation unit 210 calculates a key value of server 200 (HMAC_R) If the username and password embedded in the first key has been registered to server 200, server 200 connects to the initiator, or refuses the connection.

The method of the present invention enables identity verification for individual user using a pre-shared key, enhancing protection of personal secret data and performance of system security management.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for network security management, comprising:
establishing a user database at a server, wherein the user database comprises a plurality of first usernames and a plurality of corresponding first passwords;
embedding a second username and a corresponding second password into a shared key;
deriving a client key value from the shared key and a secret key algorithm;
adding the client key value into a first message and transferring the first message to the server; and
the server comparing the client key value with key values corresponding to the first user names and the corresponding first passwords, when the client key value matches one key value, calculating the second username and corresponding password according to a hash function algorithm to generate a server key value, and when none is matched, the connection of the second user and the server is denied.

2. The method as claimed in claim 1, further comprising step that the server calculates and obtains the first usernames and corresponding first passwords for generating the user key values before the comparing step.

3. The method as claimed in claim 1, after deriving the client key value, further comprising step that the server calculates the first user names and corresponding first passwords for generating the user key values, and restores the calculating result to the user database.

4. The method as claimed in claim 1, before deriving a client key value, further comprising step that the server calculates the first usernames and corresponds first passwords for generating the user key values, and restoring the calculating result to the user database.

5. The method as claimed in claim 1, after the comparing step, further comprising step of adding the server key value to a second message, and returning the second message to a client.

6. The method as claimed in claim 1, wherein the secret key algorithm is IKE mechanism.

7. The method as claimed in claim 1, wherein the first key is expressed as SKEYID=HMAC-MD5[(UN|PW), (N_{I}|N_{R})] for calculating the client key value, wherein the HMAC-MD5 indicates a hash function identification authorization algorithm, the UN indicates the second username, the PW indicates the second passwords, the N_{I} indicates a random number of the client, and the N_{R} indicates a random number of the server.

8. A method for network security management using an Internet key exchange mechanism, comprising steps:
establishing a user database at a server comprising a plurality of first usernames and a plurality of corresponding first passwords;
embedding a second username and corresponding password into a shared key;
deriving a client key value according to the shared key and Internet key exchange mechanism;
the server calculating and obtaining the first user-names and corresponding first passwords for generating a plurality of user key values;
the server adding the client key value into a first message and transferring the first message to the server; and
the server comparing the client key value with the user key values, and, when the client key value matches one user key value, calculating the second username and corresponding password to generate a server key value.

9. The method as claimed in claim 8, wherein when the client key value matches none user key value, the second user is denied to connect to the server.

10. The method as claimed in claim 8, after the comparing step, further comprising step of adding the server key value to a second message, and returning the second message to a client.

11. The method as claimed in claim 8, wherein the first key is expressed as SKEYID=HMAC-MD5[(UN|PW), (N_{I}|N_{R})] for calculating the client key value, wherein the HMAC-MD5 indicates—a hash function identification authorization algorithm, the UN indicates the second username, the PW indicates the second password, the N_{I} indicates a random number of the client, and the N_{R} indicates a random number of the server.

12. A system for network security management, comprising:
an analysis unit, embedding a verified name and corresponding verified password into a shared key, deriving a client key value corresponding to the verified name and verified password according to the shared key and a secret key algorithm, and adding the client key value to a first message; and
a server, coupled to the analysis unit, receiving the first message, wherein a user database located at the server comprises a plurality of verification names and corresponding verification passwords, the server comprising:
a calculation unit, coupled to the user database, calculating the verification names and corresponding verification passwords by using a hash function algorithm to generate a plurality of user key values; and
a comparison unit, coupled to the user database and the calculation unit, comparing the client key value with the user key values, and, when the client key value matches one user key value, calculating the verified name and corresponding verified password by using the hash function algorithm to generate a server key value, adding the server key value to a second message by the server, and returning the second message to the analysis unit.

13. The system as claimed in claim 12, wherein the secret key algorithm is IKE mechanism.

14. The system as claimed in claim 12, wherein the analysis unit is located at the client, enabling the verification names to be transferred to the server.

15. The system as claimed in claim 12, wherein the first key is expressed as SKEYID=HMAC-MD5[(UN|PW), (N_{I}|N_{R})] for calculating the client key value, wherein the HMAC-MD5 indicates a hash function identification authorization algorithm, the UN indicates the second username, the PW indicates the second password, the N_{I} indicates a random number of the client, and the N_{R} indicates a random number of the server.
